(19) United States
(12) Patent Application Publication
(10) Pub. No.: US 2005/0218665 A1
(43) Pub. Date: Oct. 6, 2005

(54) Resilient retaining ring for lock

(76) Inventor: Mu-Lin Shen, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/818,387

(22) Filed: Apr. 5, 2004

(51) Int. Cl. E05B 3/00

(52) U.S. Cl. 292/336.3

(57) ABSTRACT

A lock includes a hub and a spindle having an end rotatably received in the hub. The hub includes two diametrically disposed protrusions, and the spindle includes two openings. A resilient retaining ring includes a body mounted around the hub. The body includes two distal ends with an opening defined between the distal ends. The body includes two diametrically projections on an inner periphery thereof. The projections are securely received in the openings of the spindle. The resilient retaining ring further includes a tooth on an outer periphery thereof. The tooth is in contact with and thus stopped by one of the protrusions of the hub when the spindle is turned through an angle in either direction, thereby preventing further rotation of the spindle.

### BACKGROUND OF THE INVENTION

1. Field of the Invention

The present invention relates to a resilient retaining ring for a lock. In particular, the present invention relates to a resilient retaining ring that prevents an associated spindle of a lock from moving longitudinally.

2. Description of the Related Art

FIGS. 1 through 4 of the drawings illustrate a conventional cylindrical lock with lever-type handles that can be easily operated by the disabled. As illustrated in FIGS. 1 and 2, the cylindrical lock comprises an inside assembly 1, an outside assembly 2, and a latch mechanism 3. The inside assembly 1 includes an inside handle 11, an inside rose 12, an inside rose liner 13 mounted inside the inside rose 12, an inside hub 15 around which the inside rose liner 13 is mounted, and an inside spindle 16 extending through a longitudinal hole 151 of the inside hub 15. The outside assembly 2 includes an outside handle 21, an outside rose 22, an outside rose liner 23 mounted inside the outside rose 22, an outside hub 25 around which the outside rose liner 23 is mounted, and an outside spindle 26 extending through a longitudinal hole 251 of the outside hub 25. Two positioning posts 24 project from an inner side of the outside rose liner 22, with two bolts 14 extending into screw holes (not labeled) of the positioning posts 24 for mounting the lock to a door.

The inside hub 15 includes two diametrically disposed protrusions 152 to which two ends of an inside return spring (not shown) for returning the inside spindle 16 is attached. The outside hub 25 includes two diametrically disposed protrusions (not shown) to which two ends of an outside return spring (not shown) for returning the outside spindle 26 is attached. A barrel 17 is mounted between the inside hub 15 and the outside hub 25 and housed in the barrel 17. The barrel 17 is installed in a mounting hole 91 of a door 9. The latch mechanism 3 includes a retractor housing 31 located between the inside hub 15 and the outside hub 25, a retractor 32 slidably received in the retractor housing 31, and a latch 33 extendible out of the barrel 17 via a slot 171 of the barrel 17. The latch 33 has a tail (not labeled) connected to the retractor 32 to move therewith. Bolts 18 are used to connect and position the barrel 17, the retractor housing 31, the inside hub 15, and the outside hub 25.

The inside spindle 16 includes a cam 161 on an inner end thereof. The inside spindle 16 further includes two diametrically disposed openings 162 for engaging with two diametrically disposed projections 43 of an inside resilient retaining ring 4. Similarly, the outside spindle 26 includes a cam 261 on an inner end thereof. The outside spindle 26 further includes two diametrically disposed openings (not shown) for engaging with two diametrically disposed projections 43 of an outside resilient retaining ring 4. The inside resilient retaining ring 4 cooperates with the cam 161 of the inside spindle 16 to prevent the inside spindle 16 from moving longitudinally. The outside resilient retaining ring 4 cooperates with the cam 261 of the outside spindle 26 to prevent the outside spindle 26 from moving longitudinally. As illustrated in FIG. 3, the cam 161, 261 of either spindle 16, 26 is connected to an actuating portion 321 on an associated side wall of the retractor 32. Thus, when either handle 11, 21 is turned, the inside spindle 16 or the outside spindle 26 is turned, moving the retractor 32 inward and thus retracting the latch 33.

When either handle 11, 21 is turned through a predetermined angle (usually 45 degrees), further pivotal movement of either handle 11, 21 causes the retractor 32 to compress a spring 34 behind the retractor 32 until the retractor 32 is stopped by the wall 311 of the retractor housing 31, as shown in FIG. 4. Namely, the wall 311 of the retractor housing 31 defines a limit to the pivotal movement of either handle 11, 21. In FIG. 4, the latch 33 is in its fully retracted position. When either handle 11, 21 is released, the spring 34 returns the retractor 32 and the latch 33.

However, when either handle 11, 21 is subjected to a force, the resulting torque of the lever-type handle 11, 21 is relatively higher than that of a knob-type handle. Hence, when either handle 11, 21 is subjected to a relatively larger force, even if the retractor 32 has been moved to the position shown in FIG. 4, the cam 161, 261 would still impart a relatively large impact to the associated actuating portion 321, causing warping and deformation of the associated actuating portion 321. As a result, the retractor 33 could not move smoothly after a period of use. In some cases, the retractor 33 could not completely retract.

### SUMMARY OF THE INVENTION

In accordance with an aspect of the present invention, a lock includes a hub and a spindle having an end rotatably received in the hub. The hub includes at least one protrusion, and the spindle includes at least one opening. A resilient retaining ring is mounted around the hub and includes at least one projection on an inner periphery thereof. The projection of the resilient retaining ring is securely received in the opening of the spindle. The resilient retaining ring further includes a tooth on an outer periphery thereof. The tooth is in contact with and thus stopped by the protrusion of the hub when the spindle is turned through an angle, thereby preventing further rotation of the spindle.

In a preferred embodiment of the present invention, a lock includes a hub and a spindle having an end rotatably received in the hub. The hub includes two diametrically disposed protrusions, and the spindle includes two openings. A resilient retaining ring includes a body mounted around the hub. The body includes two distal ends with an opening defined between the distal ends. The body includes two diametrically projections on an inner periphery thereof. The projections are securely received in the openings of the spindle. The resilient retaining ring further includes a tooth on an outer periphery thereof. The tooth is in contact with and thus stopped by one of the protrusions of the hub when the spindle is turned through an angle in either direction, thereby preventing further rotation of the spindle.

The tooth has two opposed sides that are respectively and angularly spaced by 45 degrees from the protrusions of the hub. The tooth of the body of the resilient retaining ring is diametrically opposed to the opening of the body.

The resilient retaining ring acts as a stop for preventing warping or deformation of a retractor while preventing an associated handle from moving longitudinally.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a conventional lock.

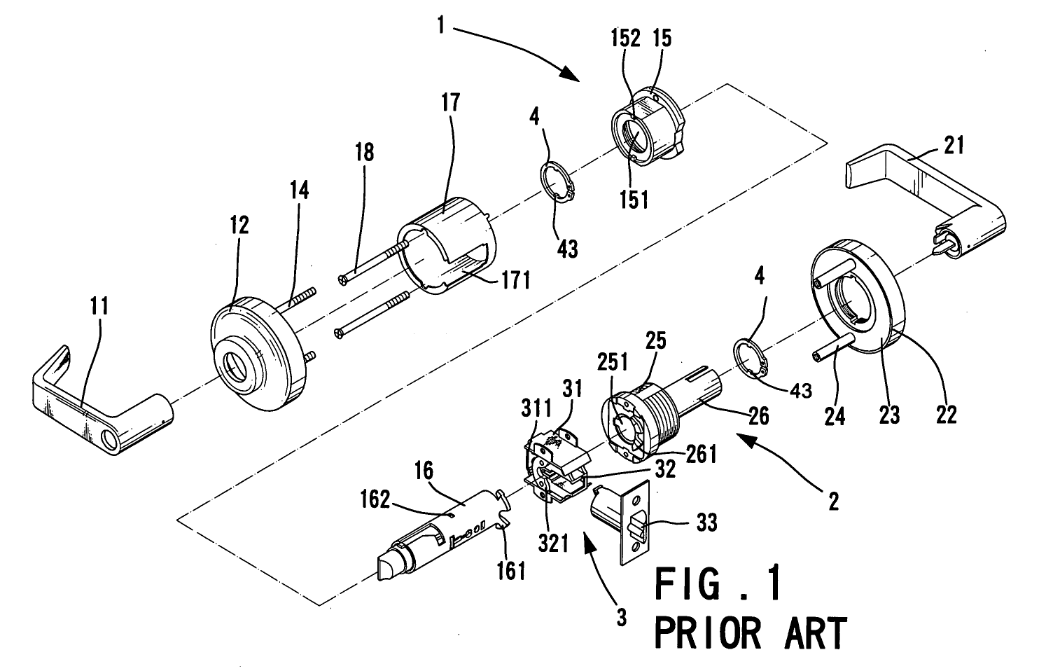

FIG. 2 is a sectional view of the conventional lock.

FIG. 3 is a sectional view illustrating structure of a latch mechanism of the conventional lock.

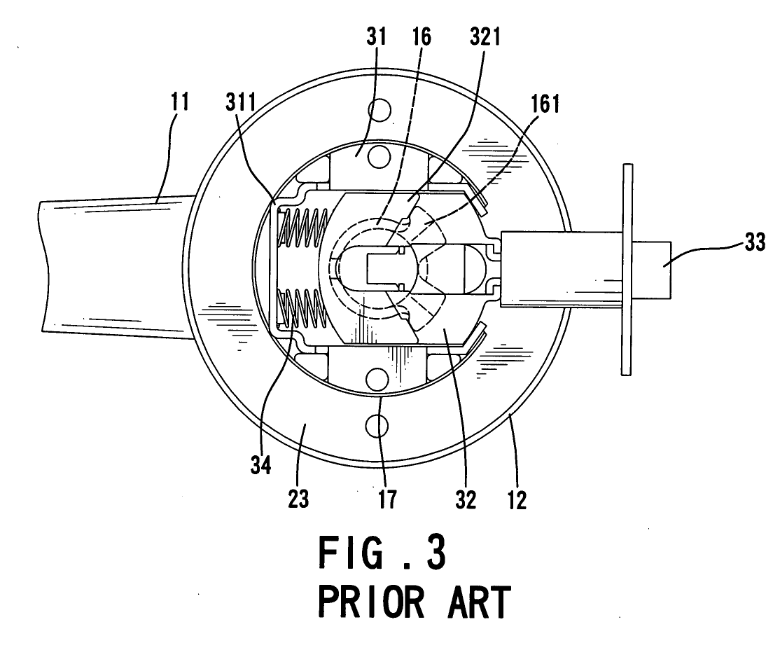

FIG. 4 is a view similar to FIG. 3, illustrating retraction of a latch of the latch mechanism.

FIG. 5 is an exploded perspective view of a lock in accordance with the present invention.

FIG. 6 is a sectional view illustrating structure of a latch mechanism of the lock in accordance with the present invention.

FIG. 7 is a view similar to FIG. 6, illustrating retraction of a latch of the latch mechanism.

### DETAILED DESCRIPTION OF THE PREFERRED EMBODIMENT

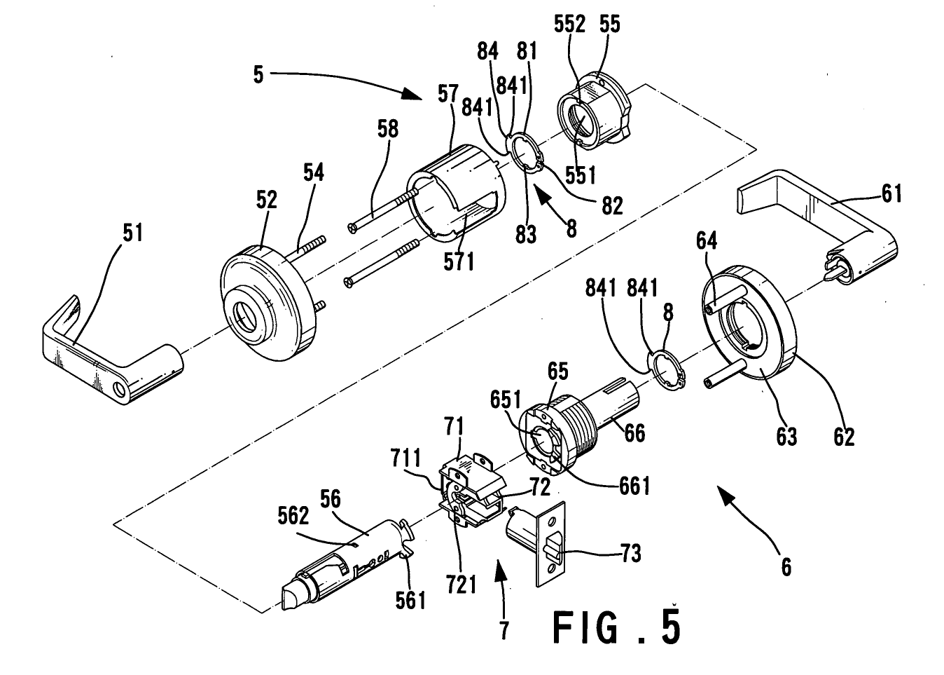

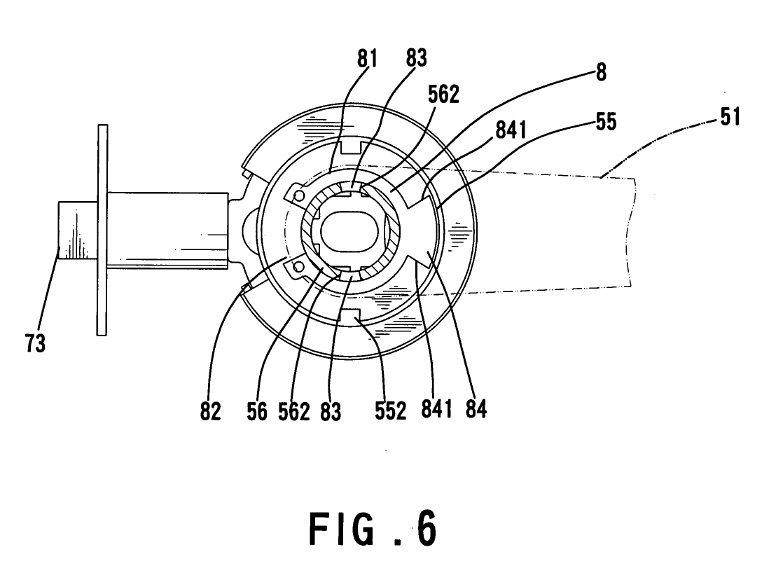

Referring to FIGS. 5 and 6, a lock in accordance with the present invention comprises an inside assembly 5, an outside assembly 6, a latch mechanism 7, an inside resilient retaining rings 8, and an outside resilient retaining ring 8. The inside assembly 5, the outside assembly 6, and a latch mechanism 7 are substantially the same as those of the conventional lock.

More specifically, the inside assembly 5 includes an inside handle 51, an inside rose 52, an inside rose liner (not shown) mounted inside the inside rose 52, an inside hub 55 around which the inside rose liner 53 is mounted, and an inside spindle 56 extending through a longitudinal hole 551 of the inside hub 55. The inside hub 55 has an end connected to the inside handle 51 to turn therewith. The outside assembly 6 includes an outside handle 61, an outside rose 62, an outside rose liner 63 mounted inside the outside rose 62, an outside hub 65 around which the outside rose liner 63 is mounted, and an outside spindle 66 extending through a longitudinal hole 651 of the outside hub 65. The outside hub 65 has an end connected to the outside handle 61 to turn therewith. Two positioning posts 64 project from an inner side of the outside rose liner 62, with two bolts 54 extending into screw holes (not labeled) of the positioning posts 64 for mounting the lock to a door.

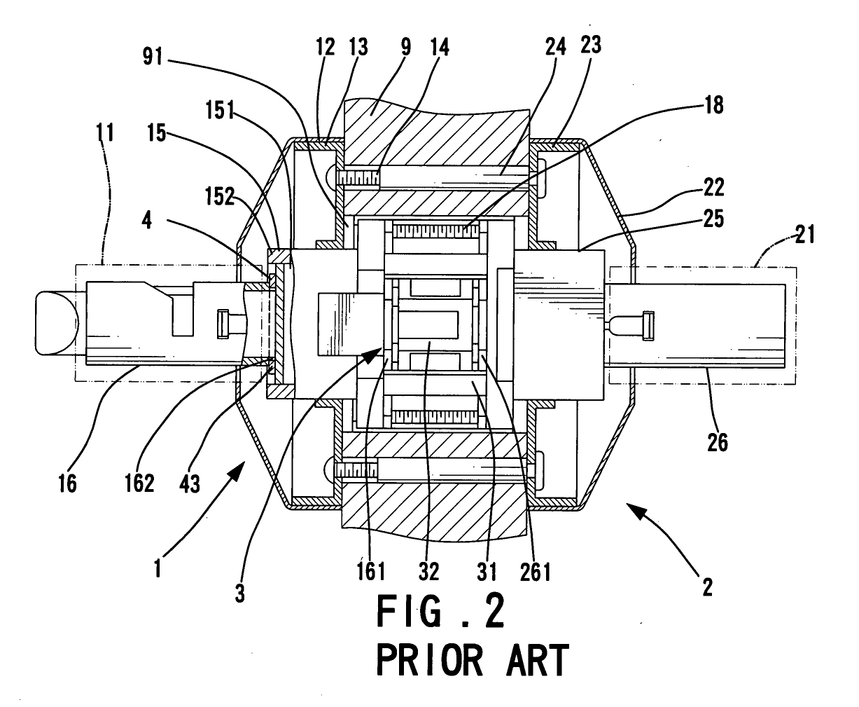

The inside hub 55 includes two diametrically disposed protrusions 552 to which two ends of an inside return spring (not shown) for returning the inside spindle 56 is attached. The outside hub 65 includes two diametrically disposed protrusions (not shown) to which two ends of an outside return spring (not shown) for returning the outside spindle 66 is attached. A barrel 57 is mounted between the inside hub 55 and the outside hub 65. The barrel 57 is installed in a mounting hole 91 of a door 9 (see FIG. 2). The latch mechanism 7 includes a retractor housing 71 located between the inside hub 55 and the outside hub 65 and housed in the barrel 57, a retractor 72 slidably received in the retractor housing 71, and a latch 73 extendible out of the barrel 57 via a slot 571 of the barrel 57. The latch 73 has a tail (not labeled) connected to the retractor 72 to move therewith. Bolts 58 are used to connect and position the barrel 57, the retractor housing 71, the inside hub 55, and the outside hub 65.

The inside spindle 56 includes a cam 561 on an inner end thereof. The inside spindle 56 further includes two diametrically disposed openings 562 for engaging with two diametrically disposed projections 83 of the inside resilient retaining ring 8. Similarly, the outside spindle 66 includes a cam 661 on an inner end thereof. The outside spindle 66 further includes two diametrically disposed openings (not shown, see 562 in FIG. 6) for engaging with two diametrically disposed projections 83 of the outside resilient retaining ring 8. The inside resilient retaining ring 8 cooperates with the cam 561 of the inside spindle 56 to prevent the inside spindle 56 from moving longitudinally. The outside resilient retaining ring 8 cooperates with the cam 661 of the outside spindle 66 to prevent the outside spindle 66 from moving longitudinally.

The inside resilient retaining ring 8 includes a body 81 with two distal ends (not labeled) defining an opening 82 therebetween. The distal ends of the body 81 can be pulled away from each other to allow the inside resilient retaining ring 8 to be mounted around the inside spindle 56. Thereafter, the inside resilient retaining ring 8 resumes its shape, which is conventional. The projections 83 are formed on an inner periphery of the body 81. Of more importance, the inside resilient retaining ring 8 includes a tooth 84 integrally formed on an outer periphery of the body 81, with the tooth 84 being located outside the longitudinal hole 551 of the inside spindle 55, as shown in FIG. 6. Similarly, the outside resilient retaining ring 8 includes a tooth 84 integrally formed on an outer periphery of the body 81, with the tooth 84 being located outside the longitudinal hole 651 of the outside spindle 55.

The cam 561, 661 of either spindle 56, 66 is connected to an actuating portion 721 on an associated side wall of the retractor 72. Thus, when either handle 51, 61 is turned, the inside spindle 56 or the outside spindle 66 is turned, moving the retractor 72 inward and thus retracting the latch 73.

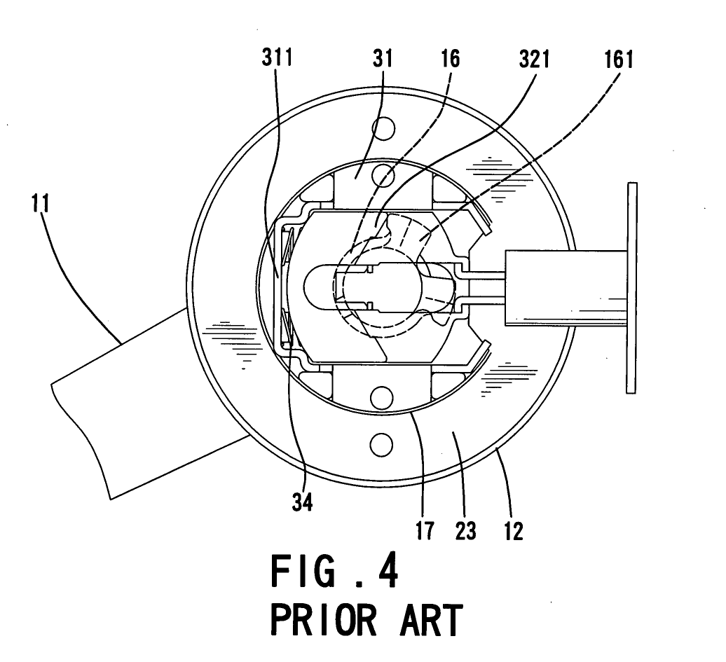

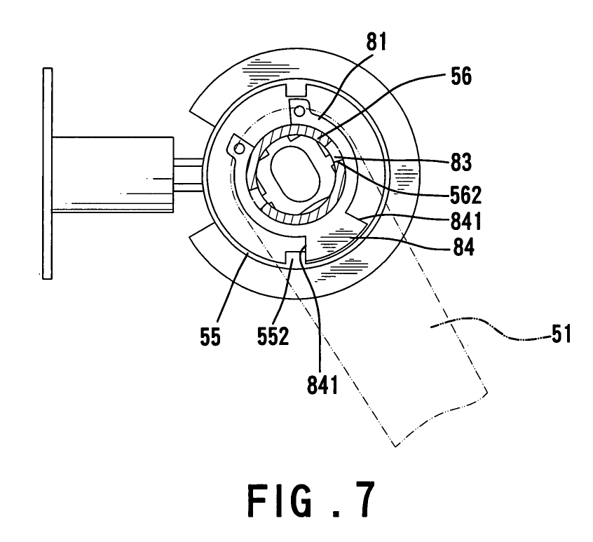

When either handle 51, 61 is turned through a predetermined angle to a position shown in FIG. 7, the tooth 84 is moved to a position in contact with and thus stopped by an associated one of the protrusions 552 of the inside hub 55 (or one of the protrusions 652 of the outside hub 65). Further rotation of either handle 51, 61 is prevented. Further, as in the conventional lock, the retractor 72 is moved inward and compresses a spring (see FIG. 4) behind the retractor 72 until the retractor 72 is stopped by the wall 711 (FIG. 5) of the retractor housing 71. This provides improved torque-resisting effect such that damage to the retractor 71 is avoided even if a large force is applied to either handle 51, 61 of lever type. As a result, warping and deformation of the associated actuating portion 721 of the retractor 72 are avoided. The latch 73 in FIG. 7 is in its fully retracted position. When either handle 51, 61 is released, the retractor 72 and the latch 73 are returned under the action of the spring behind the retractor 72.

It is noted that the tooth 84 of each resilient retaining ring 8 is diametrically opposed to the opening 82 of the body 81. Further, two edges 841 of the tooth 84 of each resilient retaining ring 8 are respectively and angularly spaced by 45 degrees from the respective protrusions 552, 652 of the associated hub 55, 65. Namely, when either handle 51, 61 has been turned through 45 degrees in either direction, further rotation of either handle 51, 61 is prevented.

Although the present invention is explained with an embodiment with two hubs, two spindles, and two handles, the present invention can be used with a lock with a single hub, a single spindle, and a single handle.

Although the invention has been explained in relation to its preferred embodiment, it is to be understood that many other possible modifications and variations can be made without departing from the scope of the invention as hereinafter claimed.

1. A lock comprising a hub and a spindle having an end rotatably received in the hub, the hub including at least one protrusion, the spindle including at least one opening, a resilient retaining ring being mounted around the hub and including at least one projection on an inner periphery thereof, said at least one projection being securely received in said at least one opening, the resilient retaining ring further including a tooth on an outer periphery thereof, the tooth being in contact with and thus stopped by said at least one protrusion of the hub when the spindle is turned through an angle, thereby preventing further rotation of the spindle.

2. A lock comprising a hub and a spindle having an end rotatably received in the hub, the hub including two diametrically disposed protrusions, the spindle including two openings, a resilient retaining ring including a body mounted around the hub, the body including two distal ends with an opening defined between the distal ends, the body including two diametrically projections on an inner periphery thereof, the projections being securely received in the openings of the spindle, the resilient retaining ring further including a tooth on an outer periphery thereof, the tooth being in contact with and thus stopped by one of the protrusions of the hub when the spindle is turned through an angle in either direction, thereby preventing further rotation of the spindle.

3. The lock as claimed in claim 2, wherein the tooth has two opposed sides that are respectively and angularly spaced by 45 degrees from the protrusions of the hub.

4. The lock as claimed in claim 2, wherein the tooth of the body of the resilient retaining ring is diametrically opposed to the opening of the body.
